(19) United States
(12) Patent Application Publication
(10) Pub. No.: US 2002/0023325 A1
(43) Pub. Date: Feb. 28, 2002

(54) Decorative casket cover system

(76) Inventors: Patrick Joseph Fant, Dallas, TX (US); Dennis Sternitzky, Plano, TX (US)

Correspondence Address: Attn. Stephen F. Schlather, BRACEWELL & PATTERSON, L.L.P., P.O. Box 61389, Houston, TX, 77208-1389, US

(21) Appl. No.: 09/845,234

(22) Filed: Apr. 30, 2001

Related U.S. Application Data
(63) Continuation-in-part of application No. 09/480,916, filed on Jan. 11, 2000.
Application No. 09/480,916 is a continuation-in-part of application No. 09/176,569, filed on Oct. 21, 1998, now Pat. No. 6,223,404.

(51) Int. Cl. A61G 17/00

(52) U.S. Cl. 27/2

(57) ABSTRACT

The present invention discloses a vault or casket having a customized design on its external surface. The invention also discloses a method for decorating the external surface of a vault or casket to produce such custom designed surface. In method ofthis invention, a substrate material is cut into panels that have shapes that correspond to the sections of the vault or casket surface. This substrate shape will enable the substrate panels to fit exactly over the corresponding surface sections. A custom design is digitally imaged onto the substrate panels. Each panel contains a portion of the overall design. The interior side of each substrate panel is provided with an adhesive material to affix the panels to the substrate surface. These substrate panels exhibiting portions of the overall design are applied sectionally to the substrate surface in a manner to provide a seamless image, thereby creating an external surface having a custom appearance. Alternatively, the method may provide for the use of a mold to heat shape the pre-printed substrate material to conform to the external dimensions of a casket. The panels may be fit onto the entire surface of the vault or casket or may be placed only on selected surfaces thereof.

### CROSS-REFERRENCE TO RELATED APPLICATION

This is a continuation-in-part of application Ser. No. 09/480,916, filed on Jan. 11, 2000, which is a continuation in part of application Ser. No. 09/176,569, filed on Oct. 21, 1998.

### FIELD OF THE INVENTION

The present invention relates to a vault or casket having a customized decorative external surface. The invention relates more particularly to a process for decorating the external surface of a vault or casket and thereby creating a vault or casket having a customized external appearance.

### BACKGROUNG OF THE INVENTION

Vaults and caskets are a symbol of death and remind people of their own mortality. For this reason, the sight or thought of a burial container can often times be disturbing. Although caskets are not necessarily a desirable discussion topic, caskets are a necessary and common part of the process of disposing of human remains. However, the fact still remains that the sight of a casket can have a depressing effect on the persons viewing a casket. Thus, there is a need to soften the visual effect of caskets to alleviate the angst of those who may be viewing such caskets.

For many years, people have tried to diminish the visual effects of burial containers. Many efforts to soften the visual effects of a casket, for instance, have focused on the interior of the casket and the position of the body in the casket. Previously, others have attempted this by creating devices to draw attention to the deceased and away from the casket's appearance. Therefore, improvements in the field of vault and casket making have centered on providing a burial container which presents the body in a restful or peaceful position for viewing by mourners.

Still other efforts to diminish the impact of a casket's appearance have focused on changing the external form of the casket. U. S. Pat. No. 5,404,627 issued to Shepherd teaches a casket arranged in a manner to imitate a bed upon which the body displayed therein is made to appear sleeping restfully.

In the past, it has not been practical to prepare a custom design that could reduce the visual effects of burial containers. As a result, choices for burial industry customers have been limited to standard finishes for commercially available burial containers. Little or no innovation in casket style and design has surfaced in the industry over the last several decades. Most changes have focused on providing an increase in the variety of available colors. There has been no practical means to truly personalize burial containers to reveal some insight into the personality ofthe deceased person. Although there has been little change in vault and casket design for some time, there is a growing desire for customized vaults and caskets. The funeral/casket industry is under increased pressure to provide options for price-sensitive buyers without sacrificing incremental margin. In addition, the funeral/casket industry has targeted pre-need purchases as a growth area. To accommodate the desires of these purchasers, the industry will need to provide custom designed caskets.

The present invention masks the environment within which the deceased is laid to rest by providing a casket cover system which has high aesthetic qualities that depart from the typical mournful funeral effect incident to prior art burial caskets. The casket cover of the present invention encourages pre-need sales by permitting individuals the opportunity to participate in their own Epilogue (how they wish to be remembered).

### SUMMARY OF THE INVENTION

It is an objective of the present invention to provide a vault or casket with a customized decorative external surface.

It is another objective of the present invention to provide a material exhibiting a custom design that can adhere seamlessly to a selected portion or the entire external surface of a vault or casket.

It is a further objective of this invention to provide a casket with an external surface that has a three-dimensional appearance as though hand painted directly onto the casket surface.

It is yet another objective ofthe present invention to provide a method for creating a custom design on the external surface of a burial container wherein a pre-printed substrate material is heat formed to conform to the external shape of the burial container.

These objects and more are provided in the present invention in which a digitally imaged wrap, cover or overlay gives the appearance of a seamless overlay once bonded to the surface of a casket. Each cover may be provided with a three dimensional image that gives the appearance of a design hand painted directly onto the container. The cover is bonded or attached in a manner to follow each curve, bend or turn on the container surface while permitting the casket to remain fully functional. The container cover provides a practical means to offer a large selection of vault and casket designs at prices competitive with standard vaults and caskets.

In one embodiment of the present invention, a digitally imaged, adhesive-backed substrate is permanently affixed to the exterior surface of a commercially available casket preferably formed with a steel surface. The imagery is specifically selected to provide a glimpse into the nature and personality of the life of the deceased. The moisture resistant substrate renders the finish highly resistant to the effects of adverse ambient conditions.

The present invention further provides a practical method for producing such a customized design for a casket. The present invention accomplishes the objective of decorating the external surface of a casket through a process that involves generating an image and affixing the image to the casket's external surface. Specifically, the desired design is applied to a substrate material which is subsequently affixed to the casket surface. In affixing the substrate material to the casket surface, the substrate material is first printed with an image and is then cut into panels that correspond to the external sections of the casket. Alternatively, individual panel sections may be precut or preformed and the image may be masked or divided to provide a corresponding image section which may be printed on a respective individual panel section. Each panel of the substrate material displays a portion of the custom design (similar to the way each piece of a puzzle displays a part of the puzzle picture). The back ofthe substrate material may be coated with an adhesive to permanently affix the substrate to the casket. The substrate can be moved and repositioned on the casket to permit accurate alignment prior to actual bonding. Once properly positioned the bonding is completed by applying light pressure to the substrate. In the preferred embodiment, the printed panels are provided with registration marks to assure proper positioning and alignment of adjacent panels in order to accomplish the seamless appearing image. Once applied, a blunt or rounded application tool may be used to press the adjoining edges in place, much in the same manner as abutting seams of wallpaper are smoothed. Any number of the external casket surfaces may be covered with substrate panels. Typically, all ofthe visible external surfaces are covered; however, in certain instances, such as where cost or installation time are a factor, it may be desireable to provide a cover only for the lid of the casket.

In an alternative embodiment, the substrate material may be formed to fit or match the external dimensions of a burial vault. Any surface may be covered, for example, the sides and/or lid.

In yet another embodiment, the desired image is applied to a substrate material which is then heat and/or vacuum formed on a mold or tool to match the exact shape of the casket. Typically, two molds are used, one for the top or lid portion of the casket and one for the bottom or base of the casket. The substrate material is heated until pliable, at which time it is fitted over the mold and a slight vacuum pulls the softened, pre-imaged substrate against the mold. The substrate is then quick cooled at which point it takes on the shape of the mold, thereby creating a single piece covering for each casket half, which may be fitted directly onto the corresponding casket portion using any suitable method. Typically, the lid cover is cut into two pieces to correspond to the two section of the lid of the casket (a casket lid commonly has a “head” section and a “foot” section) and the base cover is formed from four panels corresponding to the two sides and two ends of the casket base. The finished cover is attached to the casket with an adhesive. In this way, the present invention will require less skill and less time to install than prior art casket covers.

To maintain the integrity and accuracy of the image which is printed on the substrate, a distortion printing process is used to allow for the stretching and warping that occurs in the vacuum formation process. For instance, where the image will be stretched over a greater surface area, a “distortion factor” is calculated in the flat printed image. This may include, for example, greater color saturation in an area that will be stretched, thereby maintaining an even color across the entire image on the final product.

The method and apparatus of the invention result in caskets in which the visual effects on persons viewing such caskets are softened. Rather than drawing attention to the reality of death and mortality commonly associated with caskets, the present invention when applied to such caskets will display certain imagery that has been pre-selected by or on behalf of the deceased. The imagery covering the surface of the casket may be selected to provide insight into the personality or nature ofthe deceased. Such images may relate to family, religious belief, vocation, affiliations or life-style themes. Through the invention, it is possible to characterize, in respect and appreciation of a loved one, the custom image that is most dear and that which crystallizes the persona of the deceased. Where time and expense would render impractical the task of drawing or painting a casket with a custom pictorial, the present invention makes possible the true personalization of a casket for display and subsequent burial.

### BRIEF DESCRIPTION OF THE DRAWINGS

FIG. 1 FIG. 1 is an isometric view of a conventional commercially available casket;

FIG. 2 is an exploded view of a conventional commercially available casket showing the various sections of the casket;

FIG. 3 is flow diagram of the process of imaging a design onto the substrate;

FIG. 4a shows the acid wash step ofthe casket surface during the preparation ofthe surface for the application of the substrate material;

FIG. 4b shows the buffing step of the casket surface during the preparation of the surface for the application of the substrate material;

FIG. 4c shows the application of the primer (typically elastomeric) to the casket surface prior to the application of the substrate material to the casket surface;

FIG. 4d shows the application of a section of the substrate material to the top surface of the casket;

FIG. 5 is a cross-sectional view of the substrate and external surface of the casket;

FIG. 6a and 6b are ornamental designs that can be applied to the casket surface on top of the applied substrate material.

FIG. 7 shows a heat-formed casket cover.

FIG. 8 shows molds for forming a casket cover in accordance with the present invention.

FIG. 9 is a flow diagram of the process for creating a molded, heat formed casket cover.

FIG. 10 is a flow diagram of the process for distortion printing an image onto a substrate material.

FIG. 11 shows a cross-sectional view of the substrate and vault.

FIG. 12 shows a cross-sectional view of a casket having a substrate panel applied only to the lid.

FIG. 13 is an isometric view of a casket having a substrate panel applied only to the lid.

### DETAILED DESCRIPTION OF THE PREFERRED EMBODIMENT

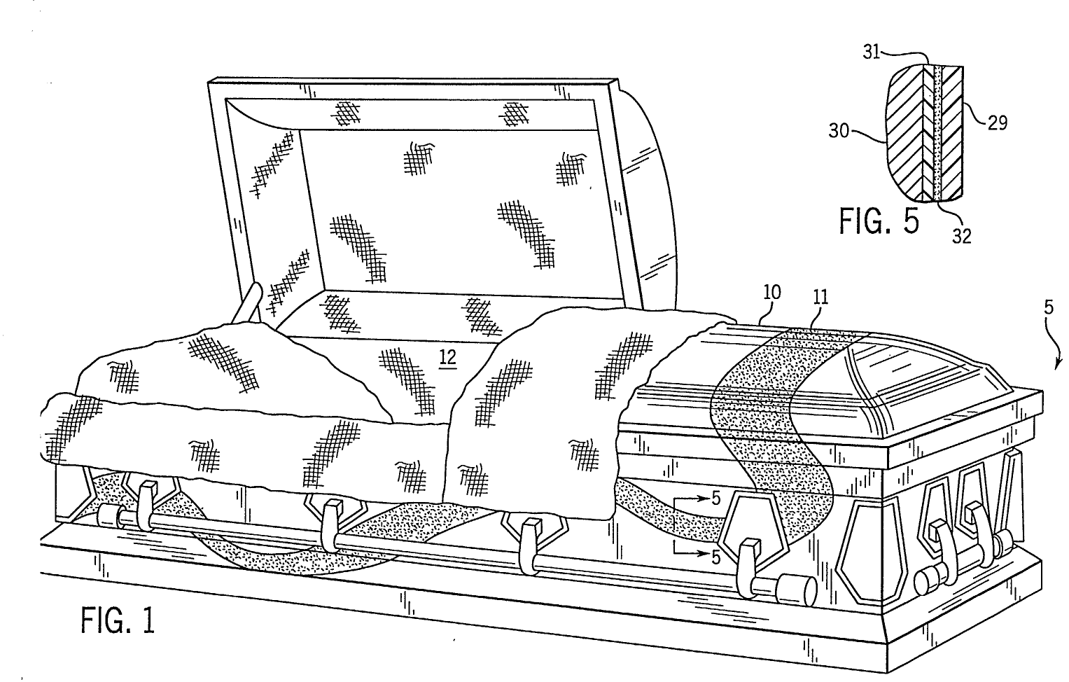

FIG. 1 shows the invention which is a casket 5 applied with a graphical design. The casket 5 comprises a conventional casket 10 with a design 11 applied to its external surface utilizing a substrate material (See FIG. 5). The conventional casket 10 has an interior section 12 surrounded by external sides. Typical conventional caskets such as casket 10 are substantially rectangular in shape. In accordance with this typical shape, casket 10 has a front side, a back side, a top side and a bottom side and a head end and a foot end. The external shape of the casket 10 is symmetrical between the front and back sides and the head and foot ends. The top side also is symmetrical between the front and back sides and the head and foot ends. As shown in FIG. 1, the external surface of the casket has numerous contours and curves. In addition, each exterior casket side and end may be comprised of a number of sections.

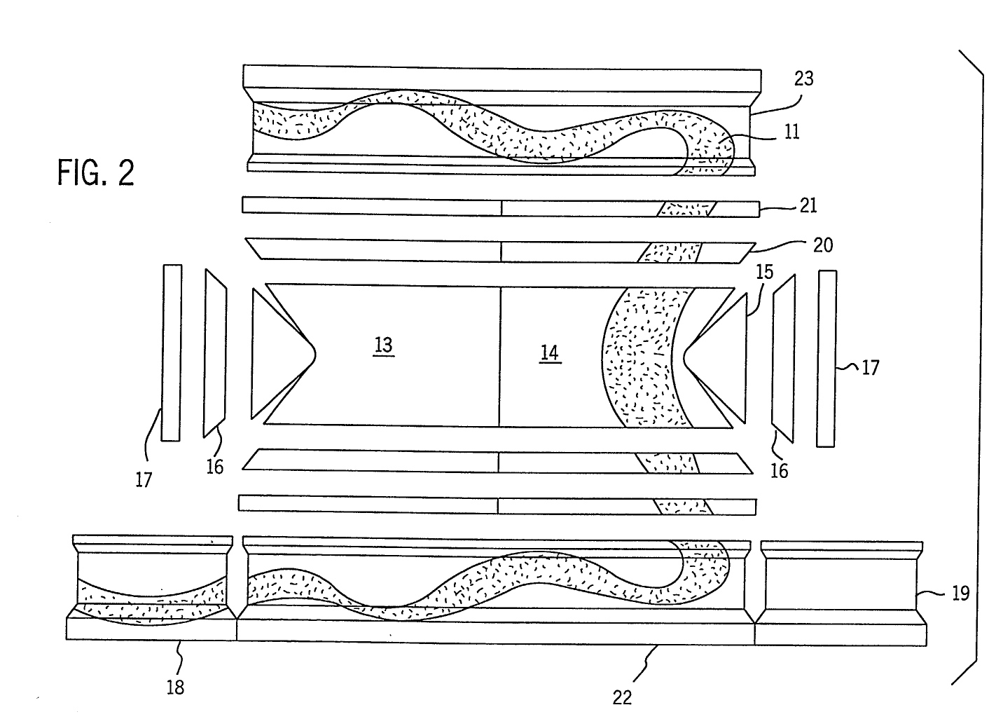

Referring to FIG. 2, the top side has two adjacent lid sections 13 and 14 respectively. Adjoining each lid section is a triangular shaped panel 15 that facilitates connection of the top side to the head and foot ends. Panel pairs 16 and 17 further facilitate joining the top side to the head and foot ends. The head and foot ends are shown as 18 and 19 respectively. Pairs of panels 20 and 21 function to connect the top side to the front and back sides. The front and back sections 22 and 23 complete the external sections of the casket.

The sections of the casket shown in FIG. 2 are used to form the template for the substrate material bearing design 11. In the present invention, a substrate material will be manufactured in panels that corresponding to the previously mentioned sections of the casket. Each manufactured substrate panel will have a shape such that it will substantially cover and conform to the corresponding section of the casket surface. In a preferred embodiment, the substrate material is approximately 4 mils thick. The design 11 is digitally imaged onto the substrate panels such that the design will appear as one uniform pictorial image once the substrate panels are attached to the casket's external surface. Following attachment of the substrate material to casket 10, the casket hardware and swing rails may then be affixed to the casket.

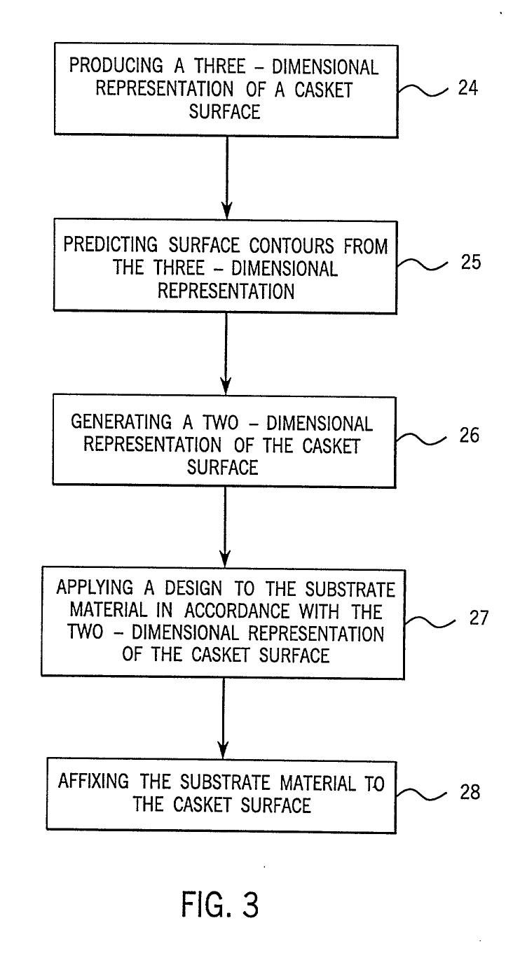

FIG. 3 shows a flow diagram of the process for placing the custom design onto the substrate panels. In this process, the present invention provides a means to introduce a 309×309 DPI pictorial image to the entire surface of a burial casket. This process begins with step 24 by producing a computer-assisted design of a three-dimensional, wire-frame representation of the casket's external surface 24 using standard modeling techniques. The next step 25 is to read the three-dimensional shape of the casket surface to predict the surface contours of the casket. In step 26, a two-dimensional shape is rendered from the casket's shape and contours, resulting in a casket substrate template which conforms to the casket sections shown in FIG. 2. The next step 27 is to digitally image the design onto a 2-mil thick adhesive-backed substrate material utilizing the template. A 4-mil substrate has also been used with good results, however the 2-mil thickness provides a panel which is more flexible and is easier mold to the contours of the casket. In the preferred embodiment, the panels are treated or coated with a clear coat liquid laminate to seal the image in the substrate and increase durability and moisture resistance. This material is subsequently cut into panels that correspond to the external casket surface sections. These substrate panels containing the portions of the design are applied sectionally and seamlessly to the casket's exterior surface in step 28. Application of the substrate panels allows full operation of the casket lid and hardware. All hinged or movable features remain fully functional. This process permits an infinite selection of consistent, pictorial images, each plotted precisely for the particular shape and size of each finished casket unit.

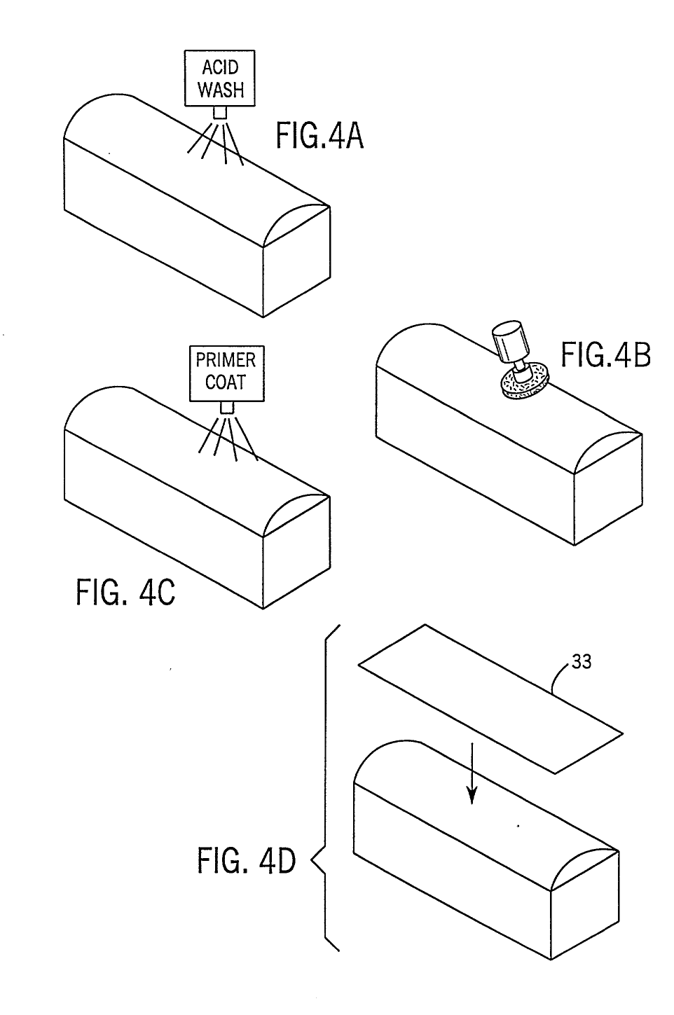

The application process will now be described in more detail. FIGS. 4a, 4b, 4c and 4d illustrate the process necessary to achieve a suitable bond between the casket surface and the substrate material. Although the digitally imaged, adhesive-backed substrate described above may be applied to caskets formed of any standard material, such as metal, wood or a composite, it has been found that the most desirable caskets for the present invention are formed with an 18 or 20 gauge, unfinished steel surface. The bonding of the of the adhesive backed material to the surface of the steel casket must not lessen the durability or negatively impact the durability or the structural integrity of the casket. Therefore, it is necessary to insure a proper bond is achieved for the metal primer. Prior to applying the substrate to the casket surface, while not required, it is preferred that the casket surface is washed with an acid neutralizer as shown in FIG. 4a. Next, the casket surface is buffed to promote optimum metal pitting and scoring which will enhance adhesion of the metal primer coating. In one preferred procedure, such buffing may be accomplished with a rotary polisher outfitted with 0.0003 grit steel abrasive buffing element. This buffing provides enhanced smoothness by minimizing surface flaws that might otherwise appear as imperfections in the imaged substrate. In any event, since the substrate material is not porous, it is necessary to eliminate moisture from the primed surface prior to application of the substrate. A petroleum distillate based primer coating containing a fast-dry agent is thus applied as shown in FIG. 4c. The application of the substrate panels 33, FIG. 4d, occurs following the primer application step.

FIG. 5 shows a cross-section of the overlay of the substrate panels on the casket surface. As shown, materials 31 and 32 adhere and affix the substrate panel 29 to the casket surface 30.

In a preferred embodiment of the invention, a template of the casket exterior is first created. This is converted to a PIXEL computer image to create masks that will cover portions of the master image that will be used in the final creation of the wrap. The art image is then color balanced using known techniques and is scaled to fit the various sides of the template in order to create a “wrap around” image. The various sections are then developed as separate files for each piece or panel of the substrate and are continually worked together in order to assure image continuity when the panels are applied to the casket, giving the appearance of a seamless image. The art work is split or divided at an appropriate place to provide a desirable image when the casket lid is in either the open or closed position. Once the image is placed on the templates, the unused portion of the image (or masked image) is removed. The full top lid portion of the image is then divided into two sections in order to accommodate a typical split casket lid.

In a preferred embodiment, the substrate material is a relatively thick, clear plastic. The thickness ofthe plastic may vary, but is typically approximately 3/32″thick. The image or a specific portion thereof may be reverse printed onto the plastic panels using an in-line press or sheet feeder. The finished solid plastic panels require less skill and less time to install than other substrate materials, such as adhesive backed roll vinyl.

The plastic panels may be provided to an installer without pre-applied adhesive. The installer will typically apply a contact adhesive to each panel and to the corresponding casket surface immediately prior to installation of the panel onto the casket. At the four corners of the casket, the edges of the panels will meet to form a joint. The edges of each panel are beveled at the joint to ensure that the individual panels meet seamlessly, without showing a gap or edge.

It is an important feature of the invention that the image can utilize the two casket end pieces or end walls so the image has continuity and wraps “seamlessly” around the ends. The ends are each created out of the front end image from both the right and left front side and is cloned and reversed (mirror image) to create the end pieces. The back panel is also a cloned, mirror image of the front panel, blended to meet the two end panels.

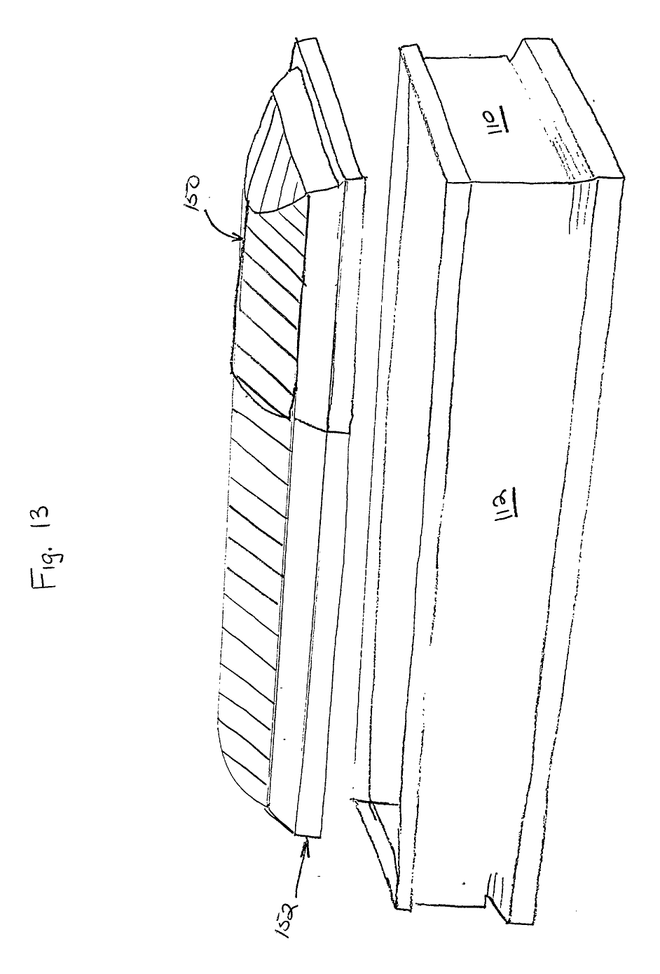

As shown in FIGS. 12 and 13, the present process may be used to produce a panel 150 which is affixed only to the lid portion 152 of the casket, as opposed to multiple panels which cover most of the external surfaces of the casket, as previously described. Such a lid cover still provides a degree of customization to the casket, but reduces expense and installation time.

To effectively mange the graphic installation around the two ends of the casket top or lid (generally in a “fish tail” shape) a separate panel is created. The shape of the four corners of the top of the lid is typically a compound curve. The shape of the fish tale panel promotes smooth installation with a single cut. Otherwise, the lid would not cover properly.

In a preferred embodiment, inlay art for the inside lid panels is also created and the entire file is merged into a production file that unites all the pieces into what appears as a continuous, seamless image over the entire exposed three dimensional surface whether the casket is opened or closed.

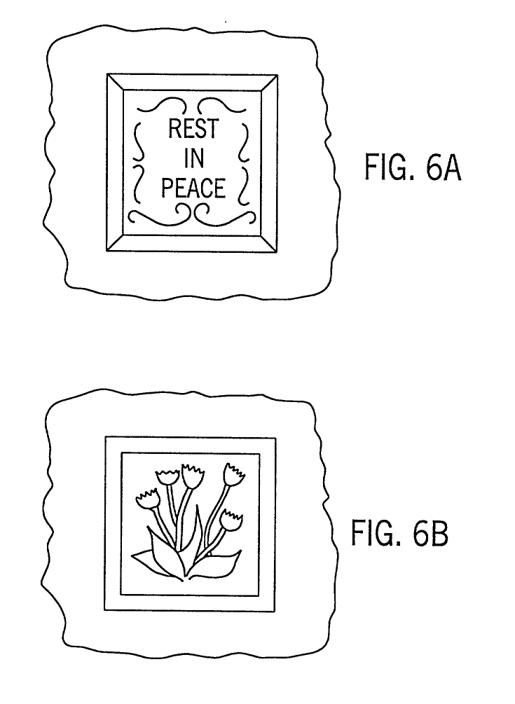

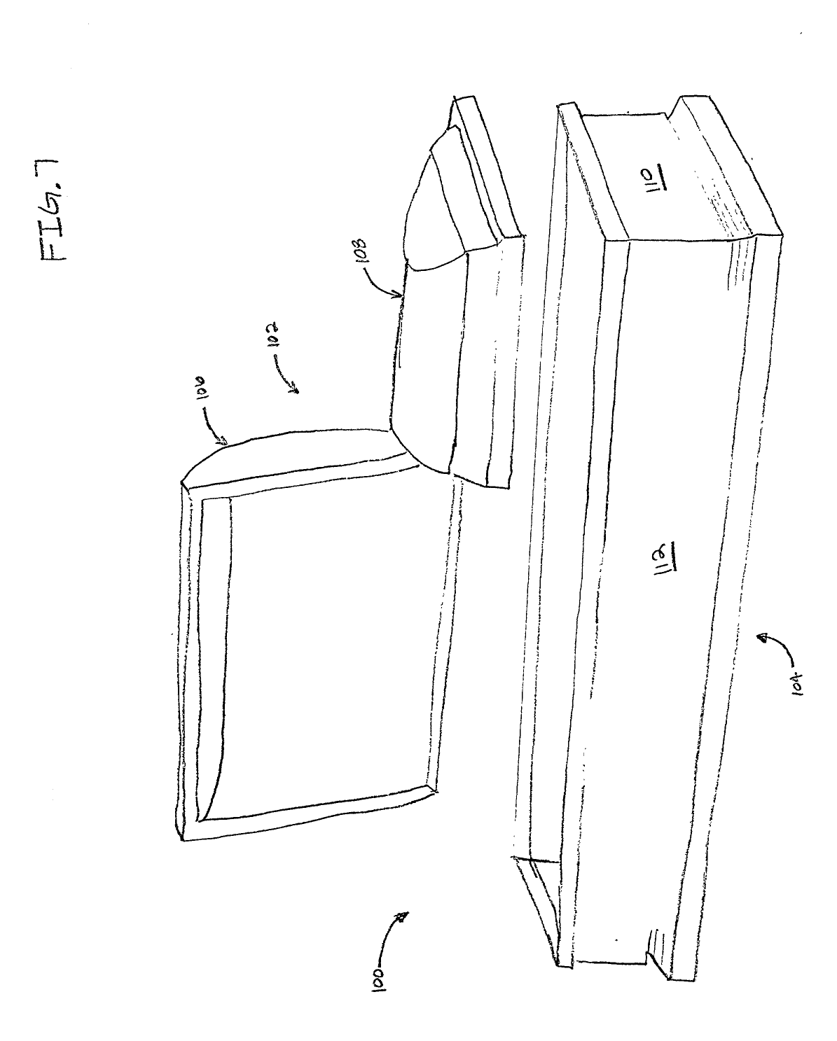

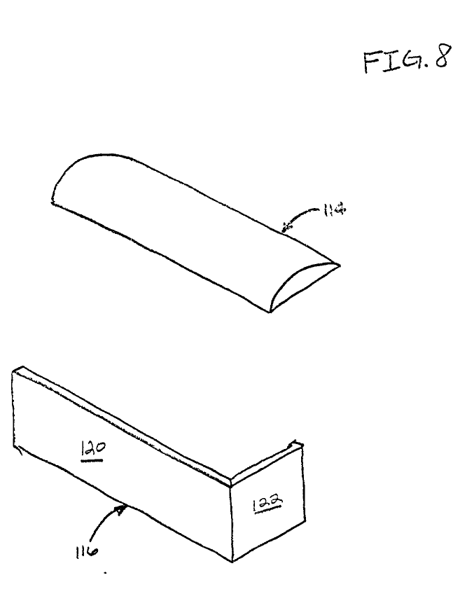

In another embodiment, once substrate 33 has been applied to the casket surface, additional designs may be applied to substrate 33 as shown in FIG. 6a and FIG. 6b.

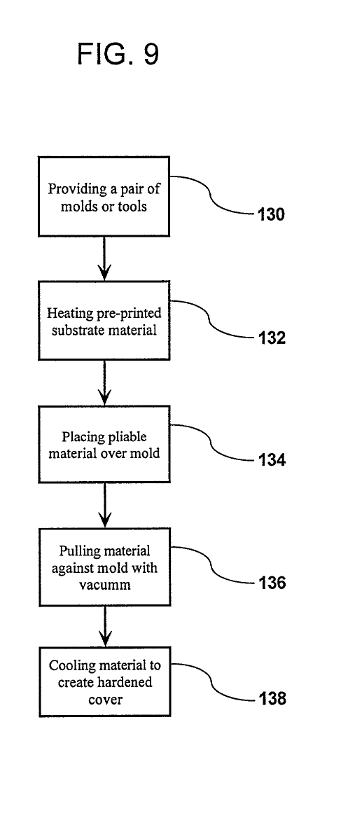

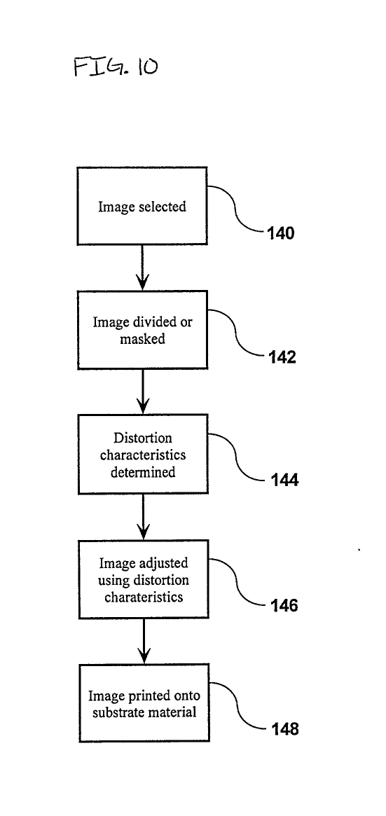

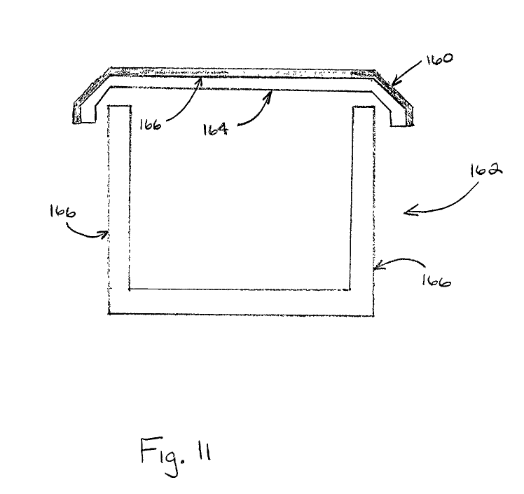

In an alternative embodiment and as shown in FIG. 7, the casket cover 100 may be a heat and/or vacuum formed, molded design, wherein, a first or lid cover 102 fits over the lid portion of the casket and a second or base cover 104 fits around the base portion of the casket. As shown in FIGS. 8 and 9, the process requires the construction of a pair of tools or molds 130. The first or lid mold 114 is a replica of the lid and the second or base mold 116 is a replica of one half of the base of the casket the cover will fit. The base mold 116 preferably corresponds to one side and one end of the casket. Each mold maybe fitted with a vacuum fitting 118. The molds 114, 116 maybe formed of any suitable material, but are preferably aluminum.

As shown in FIG. 10, a desired image is selected 140 and divided or masked to provide a lid image and a base image 142. Due to the curved and contoured nature of casket surfaces, each image may be adjusted or distorted 146 according to the specific, final, formed shape of the cover in order to produce a continuous, non-distorted final image on the formed substrate material. Preferably, the distortion process involves spatial and relational adjustment of image as well as adjustment of the color saturation. For instance, where the image will be stretched over a greater surface area, color saturation in that area may be increased prior to printing to account for dilution of the color due to the subsequent stretching. In order to determine the specific parameters 144 of the “distortion factor” to be used in the printing, a number of gridlines may be formed on a flat sheet of substrate material. The sheet is then formed using the molds and the distortion of the gridlines can be used to select appropriate distortion characteristics when printing an image. Following determination of the distortion parameters, three sheets of substrate material then selected, one sheet corresponding to either the lid cover and the other two sheets corresponding to a first base side and end cover and a second base side and end cover. The previously distorted images are then printed onto the corresponding substrate sheets. The image may be printed using any suitable method 148, but is preferably screen printed onto the substrate material. If the substrate material is clear, the image may be reverse printed onto the back or casket side ofthe material, essentially placing the image between the clear substrate material and the casket surface. Where desired, a white flood coat may be printed on top of the image in order to further distinguish or highlight the image. If the substrate material is colored, the image is screen printed onto the front or top side of the material.

The sheets are then heated 132 to approximately 1800° F., thereby making the material softer and more pliable. The heated, pliable sheet is then placed over the form 134 and a slight vacuum is used to pull the sheet down tight against the form 136. The substrate material may be of sufficient size to wrap completely around the outer surface of the mold, including the sides, ends and edges, thereby forming a cover capable of completely covering the outside of a casket. In a preferred embodiment, a first mold 114 having the shape of the lid of a casket is used to form a first sheet of substrate material. The formed substrate material is then cut into two pieces to correspond to a first, head section of the lid 106 and a second, foot section of the lid 108. A second mold 116 having the shape of one side 120 and one end 122 of the casket is used to form the second and third sheets of substrate material. After each sheet is formed and cooled 13 8, the sheet is cut to form a side section 112 which corresponds to one side of the casket and an end section 110 which corresponds to one end ofthe casket, thereby generating four separate pieces to cover the entire base ofthe casket. The sheets are preferably quick cooled using fans.

The pre-printed, heat formed panels may be attached to the casket using any suitable adhesive. Preferably, a spray-on contact adhesive which may be applied between the panels and the casket surface or a high-bond, double-sided adhesive tape are used. The contact adhesive may be applied directly to the panel, the casket or both. For the lid, each half of the lid cover may be slid from the appropriate end (i.e., the head end for the corresponding head section and the foot end for the corresponding foot section) onto the lid section of the casket. For the base, the ends of each panel are beveled to form a smooth, gaplessjoint at each corner of the casket, where the panels meet. Any handles or other hardware may be installed or attached by screwing them through the substrate material and into the casket.

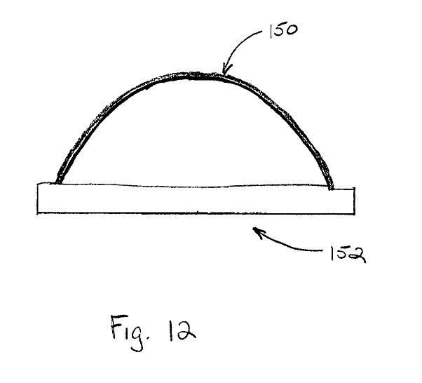

While the previous embodiments ofthe invention have been described in relation to covering a casket, it should be understood that the same techniques may be used to produce a cover for a burial vault as well. As shown in FIG. 11, a cover 160 may be produced, in accordance with the methods and techniques previously described, which may be fit over and attached to the outer surfaces 166 of the vault 162. For instance, a mold of the vault lid may be produced in order to form suitable covers using the vacuum or heat forming process. Alternatively, any suitable process may be used to produce a substrate panel which may be affixed to the external surface of the vault. Although FIG. 11 shows only a vault lid 164 having a cover or substrate panel 160 affixed thereto, any of the surfaces of the vault may be covered. Any suitable method may be used to affix the substrate to vault. Preferably, a double-sided tape adhesive is positioned along the perimeter on the underside of the cover or panel prior to affixing it to the vault surface.

The apparatus and methods of this invention provide significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention, which is limited only by the following claims.

What is claimed is:

1. A method for creating a custom design on the external surface of a burial container having external surface sections, said method comprising the steps of:
a) creating a customized design on a substrate material;
b) shaping said substrate material to conform to the external surface sections of the burial container; and
c) applying said panel of said substrate material to the external surface section of said burial container.

2. The method of claim 1 wherein said custom design is created on said substrate in accordance with the following steps:
a) generating a three-dimensional representation of the external surface of said burial container;
b) generating a two-dimensional representation of said external burial container surface from said three-dimensional representation;
c) adjusting said two-dimensional representation to account for spatial, relational and color distortion when the substrate material is shaped; and
d) applying a design to said substrate material based on the two-dimensional representation of said burial container.

3. The method of claim 2, further comprising the step of predicting external surface contours and curves before generating the two-dimensional representation.

4. The method of claim 1, wherein the substrate is affixed to the burial container using an adhesive material between the substrate and the burial container.

5. A method for creating a custom design on the external surface of a burial container having an external lid portion, said method comprising the steps of:
(a) creating a customized design on a substrate panel;
(b) shaping said panel to conform to the contours of the lid portion of said container;
(c) applying said panel to the lid portion of the container.

6. The method of claim 5, wherein said panel is shaped using a mold having the shape of the lid portion of said container.

7. The method of claim 6, wherein said panel is heated before being shaped by said mold.

8. The method of claim 7, wherein a vacuum is used to conform the heated panel to the shape of the mold.

9. The method of claim 5, wherein said custom design is created on said substrate in accordance with the following steps:
(a) generating a three dimensional representation of the external surface of the lid portion of said container;
(b) generating a two dimensional representation of said external surface from said three-dimensional representation;
(c) adjusting said image to compensate for spatial, relational and color distortion when said panel is shaped; and
(d) applying said design to said panel based on the two-dimensional representation of said container.

10. The method of claim 9, wherein said design is applied to said panel using a mirror printing process.
